(19) United States
(12) Patent Application Publication
(10) Pub. No.: US 2013/0103686 A1
(43) Pub. Date: Apr. 25, 2013

(54) METHOD AND APPARATUS FOR INTEREST MATCHING, DISCOVERY, COMMUNICATION AND COLLABORATION

(71) Applicant: STARTUP PRODUCTIONS, LLC, Philadelphia, PA (US)

(72) Inventor: James L. Sisneros, Philadelphia, PA (US)

(73) Assignee: STARTUP PRODUCTIONS, LLC, Philadelphia, PA (US)

(21) Appl. No.: 13/655,924

(22) Filed: Oct. 19, 2012

Related U.S. Application Data
(60) Provisional application No. 61/550,064, filed on Oct. 21, 2011.

(51) Int. Cl. G06F 17/30

(52) U.S. Cl. 707/736; 707/E17.005

(57) ABSTRACT

Described herein are a web-based interest matching, discovery, communication, and collaboration system and related features. The interest matching, discovery, communication, and collaboration system provides a browser add-on, an extension, a plugin and/or web site that may be used by one or more users. Via the browser add-on, extension, plugin and/or search page, a user can perform searches from multiple different Internet search engines, social networking sites, online newspapers, online magazines, content sites, eCommerce sites, libraries (as an example, university libraries), and/or databases. When the user performs a search, the interest matching, discovery, communication, and collaboration system stores information about the search including, for example, terms that the user searched for on the web-site searched and the URL, and provides information to the user that allows the user to connect to and collaborate with other users who have searched for the same or similar user inputs or search strings.

### CROSS REFERENCE TO RELATED APPLICATION

This application claims the benefit of U.S. Provisional Application No. 61/550,064, filed on Oct. 21, 2011, which is incorporated by reference as if fully set forth.

### TECHNICAL FIELD

The subject matter described herein relates to web search technologies, interest matching, discovery, social media and collaborative technologies, and other related technologies.

### BACKGROUND

For a number of years, search engines (such as Google, Yahoo, and Bing) have provided users the ability to search for content on the Internet. Recently, a number of systems have been developed that facilitate social searching. These systems are typically focused on the search results. With these systems, users can perform tasks such as personalizing search results and sharing their search results with other users. While current search systems are useful in some ways, they could be improved via the features described in detail herein.

### SUMMARY

Described herein are a web-based interest matching, discovery, communication, and collaboration system and related features. The interest matching, discovery, communication, and collaboration system provides a browser add-on, an extension, a plugin and/or web site that may be used by one or more users. Via the browser add-on, extension, plugin and/or web site, a user can perform searches from multiple different Internet search engines, social networking sites, online newspapers, online magazines, content sites, eCommerce sites, libraries (as an example, university libraries), and/or databases.

When the user performs a search, the interest matching, discovery, communication, and collaboration system stores information about the search including, for example, terms that the user searched for on the web-site searched and the URL, and provides information to the user that allows the user to connect to and collaborate with other users who have searched for the same or similar user inputs or search strings.

When users read an article on any website, the interest matching, discovery, communication, and collaboration system stores, for example, the URL, title text from the article, and/or any tags associated with the article and provides information to the user that allows the user to connect to and collaborate with other users who have read the same article or different articles and different web-sites about the same or similar topics.

Additionally, when a user texts, tweets, posts, updates, or searches the same or similar topic, the interest matching, discovery, communication, and collaboration system stores what the users texts, tweets, posts, updates, or searches and provides information to the user that allows the user to connect to and collaborate with other users who have texted, tweeted, posted, updated, or searched for the same or similar string or topic.

A user can set up multiple profiles with unique matching settings, and unlimited communities, or collaborative communities within the interest matching, discovery, communication, and collaboration system, and associate their activity (for example as described above) with specific profiles and/or communities, and/or collaborative communities. Using the profiles and/or any type of community, a user can define networks of other users, and can set permissions that control to what extent information about their searches is shared with users in these networks, and how these other users may interact with the user. Users of the interest matching, discovery, communication, and collaboration system can collaborate using email, instant messaging, chat, video conferencing, voice calls, and/or other mechanisms.

### BRIEF DESCRIPTION OF THE DRAWINGS

A more detailed understanding may be had from the following description, given by way of example in conjunction with the accompanying drawings wherein:

FIG. 1 shows an example logical architecture that includes an interest matching, discovery, communication, and collaboration system;

FIGS. 2A-2B show method(s) for using the interest matching, discovery, communication, and collaboration system of FIG. 1;

FIGS. 3-7 show examples of web pages and/or plugin content that may be generated by the interest matching, discovery, communication, and collaboration system;

FIGS. 8-9 show example methods that relate to how registration and profile management are performed with the interest matching, discovery, communication, and collaboration system of FIG. 1; and

FIG. 10 shows an example computing device that may be used to implement features described herein.

### DETAILED DESCRIPTION

Described herein are a web-based interest matching, discovery, communication, and collaboration system and related features. The interest matching, discovery, communication, and collaboration system provides a collaborative search web site that, alternatively or additionally, may include a search page, a browser add-on, an extension, and/or plugin. Via the search page, browser add-on, extension, and/or plugin, a user can perform searches from multiple different Internet search engines, social networking sites, online newspapers, online magazines, content sites, eCommerce sites, or university libraries, and/or databases, for example, web-accessible databases. When the user performs a search with this search page, browser add-on, extension, and/or plugin, the interest matching, discovery, communication, and collaboration system stores information about the search, and provides information to the user that allows the user to connect to and collaborate with other users who have searched for the same or similar search strings or topics. For ease of reference, the interest matching, discovery, communication, and collaboration system may be referred to herein as the “system” or “collaboration system.” As used herein, the term “plugin” may refer to a web browser plugin, extension, add-on, or any other type of similar technology.

When users read an article on any website, the interest matching, discovery, communication, and collaboration system stores the URL, title and/or text from the article, and any tags associated with the article and provides information to the user that allows the user to connect to and collaborate with other users who have read the same article or different articles on different web-sites about the same or similar topics.

Additionally, when a user texts, tweets, posts, updates, or searches the same or similar topic, the interest matching, discovery, communication, and collaboration system stores what the users texts, tweets, posts, updates, or searches and provides information to the user that allows the user to connect to and collaborate with other users who have texted, tweeted, posted, updated, or searched for the same or similar string or topic.

A user can set up profiles, communities, and/or collaborative communities within the interest matching, discovery, communication, and collaboration system, and associate their searches and/or search results with the profiles, communities and/or collaborative communities Using the profiles, communities and/or collaborative communities, a user can define networks of other users, and can set permissions that control to what extent information about their searches is shared with other users in these networks. Further, a user can set permissions that control the different ways (i.e., email, instant messaging, video conferencing, voice calls (i.e., VoIP calls)) that other users of the system may use to contact them to collaborate. Additionally, a web browser add-on, extension, and/or plugin may be used to interact with the interest matching, discovery, communication, and collaboration system. When a user performs a search that is not via the web site provided by the interest matching, discovery, communication, and collaboration system (i.e., via a search engine, social networking sites, online newspapers, online magazines, content sites, eCommerce sites, or university libraries, or a search/address bar in the user interface of the web browser module), then the web browser add-on, extension, and/or plugin provides information about the search to the interest matching, discovery, communication, and collaboration system, and provides information to the user about other users who have searched for the same or similar terms.

A user can create an unlimited number of collaborative communities for each profile, which has unique matching settings, Furthermore, users can join, or request an invite to public communities, which appear in search results, or users can be invited to private collaborative communities. Once a user is a member of a community, the user can add any type of item to a collaborative community, including, an update or comment, an image, a photo, a video, any type of file, ask a question, take a poll, add an event, and/or save their online research including the terms the user searched for and bookmarks. Any time an item is added, members of the community may be notified by email, an update to their page on the system, a text message, a notification via the system's mobile application, or any other notification.

The system may support persistent chat sessions, enabling users to continue their chat or instant messaging sessions as they move from web-site to website. Thus, a user may start, for example, a chat or instant messaging session while viewing, for example, a particular article or webpage, and maintain the chat while moving to another article or webpage. As an example, the web browser may continue to display the chat or instant messaging session while also displaying the new webpage or article.

The system may enable users, who may be a business of any type, to search on their products or services, their competitors' products or services or any product or service and see the number of users who have searched on the same terms. The system will provide corporate users access to online analytics of these users who have searched on the same term. Based on the analytics, a business user may bid on or purchase the right to send a product offer, advertisement, or the like to the users that searched for the relevant product. The system may require a particular deal to be presented to the users and may optionally administer the deal directly to the users.

The system may aggregate users who have searched on the same or similar products or services and notify, via email or any electronic means, any business user or business that may offer a similar product or service, thereby providing each business the ability to analyze the user data. The system may then enable businesses the ability to competitively bid on offering users, who have searched on the same or similar product or service, an offer to purchase their product. The bid may include, for example and potentially in addition to other offers, a discount or some type of promotion to the users, an incentive to the owner of the system, and/or any other special consideration. The system may extend the offer to the users on behalf of the business user and may process the transaction.

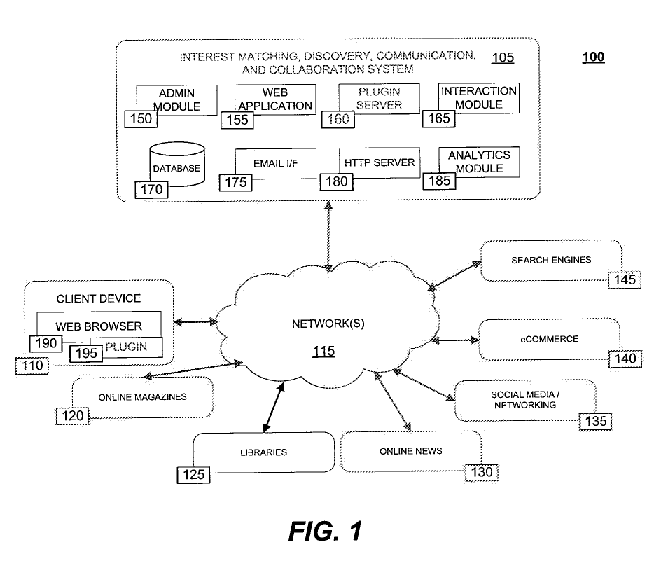

FIG. 1 shows an exemplary architecture 100 that includes an interest matching, discovery, communication, and collaboration system 105 (referred to hereinafter as “system 105” for ease of reference), a client device 110, and one or more networks 115 (referred to hereinafter as “networks 115”). The exemplary architecture 100 also includes exemplary entities that the system 105, client device 110, and networks 115 may interact with. For example, the exemplary entities may include, but are not limited to, online magazines 120, libraries 125 (for example, university libraries), online newspapers 130, social media/networking sites 135, eCommerce sites 140, search engines 145, and/or any other content sites. One skilled in the art will recognize that any other online or offline entities may be interacted with, including databases. The exemplary entities described above (or their servers) may provide search web sites that provide Internet search results, and/or may provide search results via one or more Application Programming Interfaces (APIs) or other types of interfaces, which may be based on technologies such as, for example, Representational State Transfer (REST).

As shown in FIG. 1, the system 100 may include an administrative module 150, a web application module 155, a browser add-on, extension, and/or plugin module(s) (referred to hereinafter as “plugin server module 160”), an interaction module 165, a database 170, an email interface module 175, a HyperText Transfer Protocol (HTTP) server module 180 and an analytics module 185. Details regarding each of which are described in detail below.

The web application module 155 in the system 105 may perform functionality for generating the web pages that make up a web site. The system web application module 155 may be implemented in and/or based on one or more technologies such as PHP: Hypertext Preprocessor (PHP), Java, Spring, Thymeleaf, Java Server Pages (JSP), Ruby on Rails (RoR), Active Server Pages (ASP), any server-side scripting language or web application framework, a Content Management System (CMS) technology such as WordPress, Joomla, Drupal, and/or any other appropriate technology. Alternatively or additionally, the web application module 155 may run within an application server, such as a JBoss, Tomcat, or JOnAS server.

The HTTP server module 180 may implement the HTTP protocol, and may communicate web pages (formatted as, e.g., HyperText Markup Language (HTML), eXtensible HyperText Markup Language (XHTML), or any other appropriate format) and related data for the web site using HTTP. The HTTP server module 180 in the system 105 may be, for example, an Apache HTTP server module, a Sun-ONE Web Server, a Microsoft Internet Information Services (IIS) server, and/or may be based on any other appropriate HTTP server module technology.

The email interface module 175 in the system 105 is used by the Web application module 155 for sending email messages to users of the system 105. When the email interface module 175 sends an email message, it may do so using technologies such as Simple Mail Transfer Protocol (SMTP), Post Office Protocol (POP) technology, Internet Message Access Protocol (IMAP), Remote Procedure Call (RPC) technology, and/or other appropriate technologies.

The database 170 in the system 105 may be spread across one or more computer-readable media, and may be or include one or more relational databases, hierarchical databases, object-oriented databases, one or more flat files, one or more spreadsheets, and/or one or more structured files. The database 170 may be managed by one or more database management systems, which may be based on a technology such as Microsoft SQL Server, MySQL, PostgreSQL, Oracle Relational Database Management System (RDBMS), Amazon SimpleDB, a NoSQL database technology, and/or any other appropriate technology. The database 170 may include a number of different types of data that are used by the web application module 155, administrative module 150, and/or the plugin server module 160.

The database 170 may store data that describes the user accounts for the system. This data may include, for each account, data such as the name of the account owner, an email address, phone number, and/or mailing address of the account owner, and/or other information.

The database 170 may also store user profile information. Each user may have a number of different profiles, and each profile may be associated with a different social circle or aspect of the user's life. For example, a user may have a “work” profile that relates to their workplace, a “friends” profile, one or more profiles that relate to particular interests (such as traveling or politics), and/or any other topic or aspect of their lives. In the database 170, each profile is associated with a particular email address. For each profile, a user can be associated with (i.e., have a social network of) other users. A user can also add additional information to a profile, such as a profile picture, contact information, and/or other information. The database 170 may store information that indicates the above attributes of users' profiles.

The database may 170 also store communities or collaborative communities or collaborative community information for each user. For example, at the web site, a community or collaborative community may be associated with a profile, and a user may set up a community or collaborative community and may associate searches, search strings, search results, and/or annotated search results with the community or collaborative community. Each community or collaborative community may have a name and/or title, and the user may also share information about their community or collaborative community with others. Communities may be, for example, “Public,” “Public, Invite Only,” or “Private.” “Public” communities may be joined by any user and may come up in any search results. “Public, Invite Only” communities may require, for example, an invitation and users may request an invitation, and the communities may come up in search results. “Private” communities may require an invitation and may not come up in search results. The database 170 may store information that indicates, e.g., which communities or collaborative communities are associated with which profiles, which searches and/or results are associated with which community or collaborative community, the names and/or titles of the communities or collaborative communities, and/or other information. Alternatively or additionally, the database 170 may store information about results for each search that has been performed, and/or annotations that the users have made to the search results.

The database 170 may also store information about searches that have been performed by users. For each search that the database 170 stores information about, the database 170 may store an entry including, for example, one or more of: a unique identifier for the search; a timestamp that indicates the time the search was performed or the time that the information about the search is being added to the database; the IP address of the device from which the search was performed; the search engine/database the search is associated with; the user agent (i.e., an identifier of the web browser application the search was performed with); the community or collaborative community the user is currently searching with; the profile the user is currently searching with; and information that indicates the source of the search (i.e., whether it comes from the search page of the web site or from a, a browser add-on, extension, and/or plugin); an identifier of the user that performed the search; and/or other information.

Alternatively or additionally, the database 170 may also store an index or related data structure that relates to searches that users have performed. This index may be based on and/or constructed using a technology such as Apache Lucene, and/or any other technology that facilitates text searching and/or fuzzy text searching, fuzzy matching algorithms and/or machine learning algorithms.

The database 170 may also store information about permissions that users have set with respect to sharing search information with other users. For example, a user may set permissions (using the web site) that indicate that they permit sharing of information about their searches only with certain users. This information may indicate that search information may be shared only with a specific individual user, the users within a given domain (such as a top-level domain such as .edu or .gov, or a corporate or organization domain), a group of users that is specifically-defined by the user, the group of users that make up a social network, one or more specific members in a social network, and/or any group of users. Additionally, a user may set permissions that indicate whether they may be contacted to collaborate and what communication methods (i.e., email, instant messaging, video call, or voice call) may be used to contact them. The above-mentioned permissions types (i.e., which users can find search results and the types of communications methods that may be used) may be configured on a per-profile and/or per-community/collaborative community basis. As one example, a user may set permissions that indicate that they may be contacted by any user via email to discuss searches related to a first community or collaborative community, but that they may only be contacted via email to collaborate on a second community or collaborative community. The database 170 may store information that indicates the above above-mentioned permission-related information.

The database 170 may also store information about the sharing of information that users have performed. For example, the web application module 155 provides web pages that permit users to share search results, search result annotations, and/or search strings via external web sites, such as Twitter, Facebook, and/or other sites. The database 170 may store information about the shared information, such as what it is (search results/annotated search results/search string), who it was shared with, the external web site by which it was shared, and/or when the sharing took place.

The database 170 may also store information about the different search engines and/or databases that are available for use with the system. This information may include web addresses associated with the search engines, APIs and/or other interfaces that the search engines provide, and/or other information.

As described herein, modules (such as the administrative module 150, web application module 155, the plugin server module 160, interaction module 165, analytics module 185, and email interface module 175) in the system 105 may obtain data from, add data to, and modify data in the database 170. When these modules obtain data from, add data to, and/or modify data in the database 170, they may do so using technologies such as Structured Query Language (SQL), the Java Persistence API (JPA) and the Java Persistence Query Language (JPQL), an object/relational mapping technology, and/or any other appropriate technology.

The administrative module 150 in the system 105 may perform functionality for administering the interest matching, discovery, communication, and collaboration functionality. A graphical user interface provided by the administrative module 150 may allow administrative users to perform functions such as administering user accounts, adding new search engines/databases that may be used with the web site, and/or other functionality.

The analytics module 185 of the system 105 may perform functionality such as analyzing the data in the database 170 in the system. By analyzing the data, the analytics module 185 may, for example, search for and analyze trends in search data. Further, the analytics module 185 may determine when users of the system 105 have searched for particular products/service, and then the results may be used to offer marketing promotions to the users.

The interaction module 165 in the system 105 may implement functionality related to instant messaging, video calls, and VoIP calls between users of the system 105. In various implementations, the interaction module 165 may establish peer-to-peer instant messaging/video call/VoIP call sessions between users, may establish instant messaging/video call/VoIP call sessions between users and then handoff the routing of the session data between the users to servers (not depicted in FIG. 1) that are external to the system 105, may itself route data for instant messaging/video call/VoIP call sessions between users, and/or may perform other functionality related to the establishment and/or performance of instant messaging/video call/VoIP call sessions between users. The interaction module 165 may implement technology such as PubNub, and/or any other appropriate technology.

The plugin server module 160 in the system may receives information from a web browser, browser add-on, extension, and/or plugin that are used with the system. Further details regarding the plugin server module 160 are provided below.

The client device 110 shown in FIG. 1 may be, for example, a desktop computer, a laptop computer, a netbook, a tablet computer, a personal digital assistant (PDA), a cellular phone, or any other appropriate device. Via a web site or plugin provided by the system 105, the user of the client device 110 may perform actions such as opening a user account, managing profiles and search communities or collaborative communities, performing searches, and interacting with other users of the system 105.

As shown in FIG. 1, the client device may include a web browser module 190. Alternatively or additionally, the web browser module 190 may be or include a browser add-on, extension, and/or plugin 195, sometimes referred to herein as “plugin 195” for ease reference. The web browser module 190 in the client device may include and/or communicate with one or more sub-modules that perform functionality such as rendering HTML (including HTML5), rendering raster and/or vector graphics, executing JavaScript, and/or rendering multimedia content. Alternatively or additionally, the web browser module 190 may implement Rich Internet Application (RIA) and/or multimedia technologies such as Adobe Flash, Microsoft Silverlight, and/or other technologies. The web browser module 190 may implement RIA and/or multimedia technologies using one or web browser add-on, extension, and/or plugin modules 195 (such as, for example, an Adobe Flash or Microsoft Silverlight plugin), and/or using one or more sub-modules within the web browser, add-on, extension, and/or plugin module 195 itself.

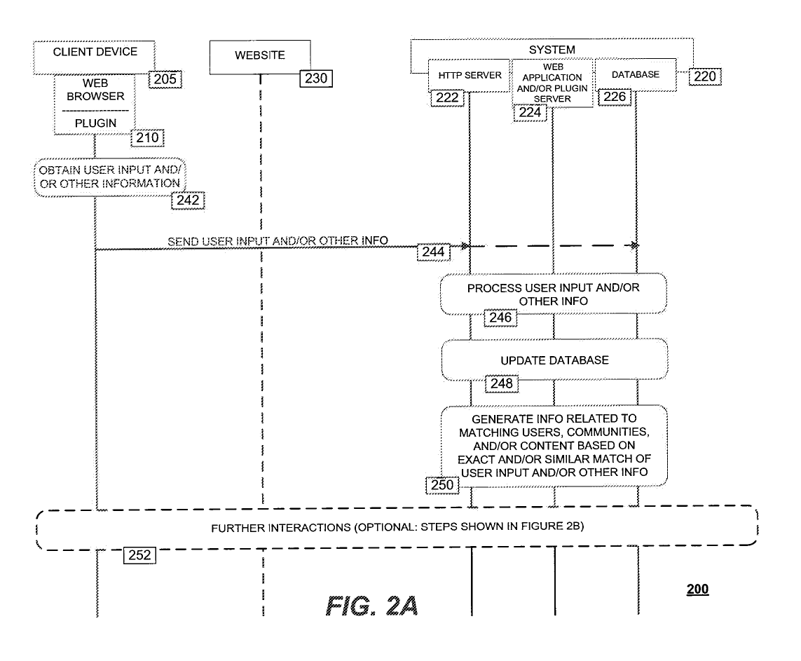

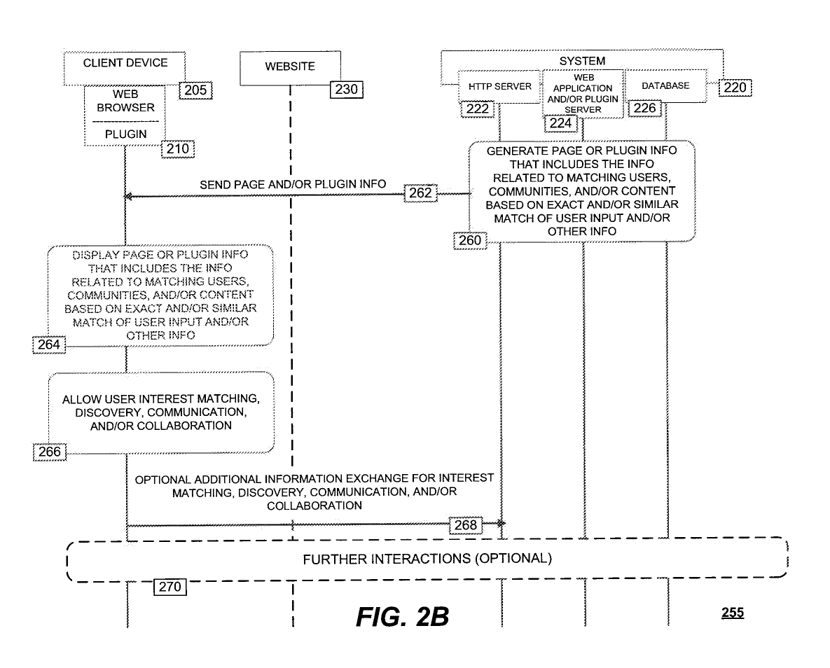

As shown in FIG. 1, the web browser module 190 may also include and/or interact with the browser add-on, extension, and/or plugin module 195. The browser add-on, extension, and/or plugin module 195 may be implemented using technologies such as Component Object Model (COM), ActiveX, Javascript, DHTML, XML User Interface Language (XUL), and/or any other appropriate technology. When the browser add-on, extension, and/or plugin module 195 is activated and a user performs a search of a search engine using the web browser module 190 (and the search is not performed from the search page provided by the system 105), the plugin module 195 may send information to the plugin server module 160 in the system 105 regarding the search. The plugin server module 160 may then store this information in the database 170 in the system 105. The plugin server module 160 may then provides information to the plugin module 195 about other users of the system 105 that have searched for the same or similar terms. Further details regarding the interactions between the plugin module 195 and the plugin server 160 in the system 105 are provided below, including with reference to FIGS. 2A-B.

Although not shown in FIG. 1, the client device 110 may alternatively or additionally include a number of other modules, such as an email client module (such as Microsoft Outlook, a Google Gmail mobile application), a chat/instant messaging module, a Skype application or other Voice over IP (VoIP) client application, and/or other appropriate modules.

The one or more networks 115 shown in FIG. 1 may include one or more private and/or public networks, and may include the Internet. The one or more networks 115 may include wired and/or wireless networks (such as cellular and/or wireless local area network (WLAN) networks), and may be based on technology such as Internet Protocol (IP). Communication between the client device, system, and search engine servers takes place via the one or more networks 115.

The system 105 (and the database 170 and modules described herein as included in the system 105) may be implemented using cloud computing technologies, such as Amazon Elastic Compute Cloud (EC2) technologies, Windows Azure technologies, and/or any other appropriate cloud computing technologies.

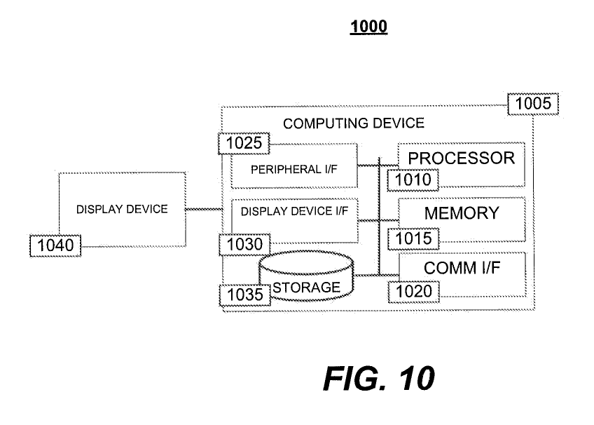

Each or any combination of the modules shown in FIG. 1 and/or described herein (including the administrative module 150, web application module 155, plugin server module 160, email interface module 175, HTTP server module 180, analytics module 185, interaction module 165, web browser module 190, and the plugin module 195) may be implemented as one or more software modules. Suitable software modules include, by way of example, an executable program, a function, a method call, a procedure, a routine or sub-routine, one or more processor-executable instructions, an object, or a data structure. These modules are described herein as performing various actions; however, this is done for ease of description and it should be understood that the actions described herein as performed by each or any of these modules are actually performed by one or more processors (in conjunction with one or more memory devices and/or other hardware elements, such as those shown in and described below with reference to FIG. 10) that execute the instructions and/or otherwise perform the behaviors defined by the modules.

For ease of description, FIG. 1 shows a single client device and one of each of the other entities. However, it should be understood that any number of client devices and/or entities may be used with the architecture of FIG. 1.

FIGS. 2A-2B show example methods 200, 255 for interaction between a client device 205, system 220, and/or website 230. The client device 205 may be used to perform a search using a search page provided by the system 220. The client device 205 may include a web browser and/or plugin module 210. Thus, the client device 205 may include a web browser or may include a plugin, or any a combination of the two. As described above in detail, the term “plugin” may be used to refer to, for example, browser add-on, extension, and/or plugin. The web browser portion may be used for example on a site provided by the system 220 described herein. The plugin portion may be used for example at any site, including a site not provided by the system 220. The system 220 may include the HTTP server, web application, the database and/or any of the other modules described, shown, or mentioned with respect to FIG. 1. The website 230 may include any website, including for example, the entities described, shown, or mentioned with respect to FIG. 1. A user (not shown) of the client device 205 may be using the website 230 to perform any type of search or information retrieval. The user may interact with the website 230 via the system 220. The interaction may include use of the web browser and/or plugin 210. In the example of FIGS. 2A-2B, the user of the client device 205 is named John Smith, John Smith is performing a search on the search string “Apple iPhone,” and Search Engine Server A is operated by Bing. As will be described in further detail below, the client device 205 may obtain the results of the search directly from the website 230. As an example, the client device 205 may be browsing the website 230 and see the results there, while the client device 205 also interacts with the website 230 and/or system 220 to exchange information with the system 220. Alternatively or additionally, the client device 205 may obtain the results of the search routed through the system 220. For example, the system 220 may obtain the search results on behalf of the client device 205, and then forwards them to the client device 205. FIGS. 2A-2B show examples that may include instances in which the client device 205 obtains the search results directly and in which the search results are routed through the system.

As an example, at the beginning of the method 200 of FIG. 2A, the user has logged in to the system 220. The user may log in to a specific profile by using the user name and/or email address associated with that profile. Alternatively or additionally, after logging in, the user may select a different profile as their active/current profile. While receiving matching information or any other information as described throughout the present disclosure, a user may be able to determine or view other users (or how many users) matched their user input in their other profiles. This may include other profiles that are not currently selected. For example, a user using a “friends” profile may be able to see that a given number of connections are available based on a user input in their “work” profile. However, the connections in the “work” profile may not receive information with respect to the user and the user input. This may occur, for example, until the user selects the “work” profile. Further, a user may select a community or collaborative community as their active/current community or collaborative community, such that searches that the user performed (and/or related information) may be stored and associated with the active/current community or collaborative community. It should be noted, however, that the user need not have an active/selected community or collaborative community at a given time. When the user has logged in, the web application module 155 may store information such as an identifier of the user, a current profile and community or collaborative community for the user (if applicable), a session identifier associated with the current application session, and/or other information.

As shown in FIG. 2A, at step 242, the web browser and or plugin module 210 may be used to obtain user input and/or other information from the user of the client device 205. The user input and/or other information may include a search string, a captured URL, a captured title (for example, an article title), some or all text (for example, of an article or any other data source viewed via the client device 205), tags, and/or other similar information. Similarly, the client device 205 may capture other user actions such as, for example, texting, tweeting, posting, checking-in, or other actions. These actions may be performed and/or captured, for example, via a mobile application. The web browser and/or plugin module 210 may receive the user input and/or other information, via for example, a text field, a mouse click, or any other user input. Although not specifically shown in FIG. 2A, the client device 205 (for example, via the web browser and/or plugin module 210) may have interacted with the system 220. For example, the interaction may be with or between the HTTP Server 222, the web application and/or plugin server module 224, and/or the database 226 at the system 220.

At step 244, the client device 205 may send the user input and/or other information obtained. The user input and/or other information may be sent to the system 220, which may include the HTTP server 222, the web application and/or plugin server 224, and/or the database 226. The user input and/or other information may also be used, received, or communicated via the website 230.

At step 246, the user input and/or other information is processed. This may include the HTTP server module 222 passing the user input and/or other information to the web application and/or plugin server module 224. In one example, the web application and/or plugin server module 224 sends the search string (in this example, “Apple iPhone”) and related information to the HTTP server module 222 in one or more messages, which may be or include one or more HTTP POST requests. The related information sent to the HTTP server 222 may include information that indicates the target search engine and/or any other information, for example, the information described above as being captured. The other information passed to the web application and/or plugin server module 224 may include, for example, one or more of: the IP address used by the client device; user agent information (i.e., an identifier of the web browser module); the target search engine; the community or collaborative community the user is currently searching with (if applicable); the profile the user is currently searching with; and/or other information.

Upon receiving the user input and/or other information, the web application and/or plugin server module 224 may add one or more entries to the database 226. For example, at step 248, the database may be updated. The entry may include one or more of: a unique identifier for the entry; a time the entry is being added; the IP address used by the client device; the target search engine; the user agent; the community or collaborative community the user is currently searching with (if applicable); the profile the user is currently searching with; information that indicates the source of the search (i.e., that it comes from the search pages or from a browser add-on, extension, and/or plugin); and an identifier of the user. The entry may also include any of the user input and/or other information described above. In an instance where the database is a relational database, the entry may include, for example, adding one or more rows that indicate the above-mentioned information to a table.

At step 250, the system 220, including, for example, the web application and/or plugin server module 224, may generate information related to matching users, communities, and/or content based on an exact and/or similar match of the user input and/or other information received in any of the previous steps. This may also include other information that may be used for collaboration between the searching user and other users of the system. The information generated at this step may be referred to as “generated information,” “matching information,” or other similar terms. The generating the matching information 250 may be performed in any order or in any combination with the updating 248 the database 226.

To generate the matching information, the web application and/or plugin server module 224 may query the database 226 to obtain records related to users who have searched for exactly the same user input, for example, a string used as the search string. Alternatively or additionally, the web application and/or plugin module 224 may use a text search and/or fuzzy matching algorithms and/or machine learning algorithms to search an index in the database 226 to obtain information related to users who searched for exactly the same or similar user input and/or other information (for example, a search string). This also may be performed using a text search and/or fuzzy matching algorithms and/or machine learning algorithms, such as Apache Lucene, and/or via a matching technique such as the Levenshtein Distance technique, Edit Distance technique, and/or any other appropriate technique. Alternatively or additionally, the web application and/or plugin server module may limit these search results, such that they include only searches for the same/similar user input (or other information or search string) that were performed with a given time frame, such as within the past hour, past day, past week, past month, or any other time period.

To generate the matching information, the web application and/or plugin server module 224 may also access the database 226 to obtain information related to the permissions set by users. Using this information, the web application and/or plugin server module 224 may determine whether information about users that have searched for the same and/or similar user input (string) as the search string should be included in the matching information, and (if applicable) may determine what forms of contact (i.e., email, instant messaging, etc.) are authorized for the user to contact the users that have searched for the same and/or similar input. The web application and/or plugin server module 224 may include (or does not include) this information in the matching information as indicated by the permissions. For example, if a second user (Jane Smith) has authorized John Smith to obtain information about her search results and Jane Smith has searched for a same and/or similar user input (for example, search string), then the web application and/or plugin server module 224 may include information regarding Jane Smith in the matching information; alternatively, if Jane Smith has searched for a same and/or similar user input (search string) but John Smith is not authorized to access information regarding Jane Smith (because, for example, John Smith is not in any of Jane Smith's networks), then the web application and/or plugin server module 224 does not include information regarding Jane Smith in the matching information.

The matching information generated by the web application and/or plugin server module 224 may include, for each of the users that have searched for a same and/or similar user input (search string) and whose information is accessible to the searching user, one or more of: the name of the user; an identifier of the user; a user name of the user; an email address of the user; contact information for the user in a third-party communication network (such as a for use with a VoIP service, such as Skype); information about an avatar/profile image associated with the user; and/or other information.

Alternatively or additionally, the matching information may include information such as: the most popular search strings that have been searched for by all users of the system within a given time frame (such as within the last day, week, or month); the number of users that have searched for the most popular search strings; the most popular searches within a given network of the user of the client device (i.e., the most popular searches performed by all users associated with a given profile); the number of users that within a given network of the user of the client device that have searched for the most popular search strings; information such as that shown in, for example, a “Collaborate” area in a web page or plugin, which will be described in detail below; and/or other information.

At step 252, further interactions may be performed via any combination of the client device 205, the website 230, and/or the system 220. For example, additional user input and/or other information may be obtained or the user input and/or other information may be processed, stored in the database, or otherwise used to generate matching information. Similarly, any or all of the steps described below with respect to FIG. 2B may be performed.

With any of the steps described herein, the web application and/or plugin server module 224 may determine the approach that will be used for communication of search results to the client device, for example, whether search results for the search should be obtained via direct interactions between the web browser and/or plugin 210 and the target website 230, or whether the system 220 should obtain the search results from the website 230 and then provide the search results to the web browser and/or plugin 210. This may be based on information stored by the web application and/or plugin server 224 that indicates that, for a given website or search engine, which approach should be taken. Similarly, this may be determined by whether the client device 205 is using the website of the system 220 described herein or whether the client device 205 is using a plugin as described herein.

FIG. 2B shows an example method 255 for interaction between a client device 205, system 220, and/or website 230. At step 260, the web application and/or plugin server module 224 may generate a page or plugin information that includes, for example, the information generated at step 250. The page or plugin information may include the information related to matching users, communities, and/or content based on an exact and/or similar match of the user input and/or other information. The generated page or plugin information may also include information that relates to a query for the search results. For ease of description, the information that relates to the query for the search results is referred to as “search information.” The search information may include one or more instructions that, when executed by the web application and/or plugin server module 224, cause the web application and/or plugin server module 224 to interact with the website 230 to obtain the search results. Alternatively or additionally, the search information may include one or more parameters such as the user input search string (in this example, “Apple iPhone”) and/or other information, a target search server (in this example, website 230), and/or other information. In an instance where the search information includes one or more instructions, the instructions may be Javascript code, and/or may be defined according to a technology such as JQuery or a similar technology. As will be explained in detail below, plugin information may also be generated based on the user input and/or other information obtained and the results received by the client device 205 at website 230.

At step 262, the system 220 (for example, the HTTP server module 222) may transmit the generated page or plugin info (for example, including the matching information and/or the search information) to the client device 205.

At step 264, the web browser and/or plugin 210 of the client device 205 may display the page or plugin information that includes the information related to matching users, communities, and/or content based on an exact and/or similar match of user input and/or other information (for example, referred to as “generated information” or “matching information” herein). The web browser and/or plugin 210 may similar display the search information and/or any other information. The web browser and/or plugin 210 may perform one or more actions for execution of the query for the search results, as indicated in the search information. In an instance where the search information includes one or more instructions (such as Javascript code) that may be executed by the web browser module, this may include the web browser and/or plugin 210 executing the one or more instructions. Based on step 264, or any other step, the client device 205 and/or the system 220 may interact with the website 230 to, for example, display information, receive information, and/or exchange information. For example, if the website 230 is a search engine, the web browser and/or plugin 210 may send one or more search request messages to the website 230, as defined by and/or indicated in the search information.

The exchange of information described by any of the steps described herein may be performed using a number of different technologies. For example, messages exchanged may be based on technologies such as JavaScript Object Notation (JSON), REST, XML, Simple Object Access Protocol (SOAP), a remote procedure call (RPC) technology, an object serialization technology (such as Serialized PHP (SPHP) or any other object serialization technology), and/or the messages may be defined according to any other appropriate format.

At step 266, the client device 205, including the web browser and/or plugin 210 may allow user interest matching, discovery, communication, and/or collaboration. This interest matching, discovery, communication, and/or collaboration may be based on any of the information described above, for example, the user input, the other information, the matching information, and/or the search information. The information displayed to the user and the options provided to the user for interest matching, discovery, communication, and/or collaboration may include any of the features described herein as provided by the system described in the present application.

For example, as described above, a user may set up multiple profiles with unique matching settings, and unlimited communities, or collaborative communities within the interest matching, discovery, communication, and collaboration system, and associate their activity (for example as described above) with specific profiles and/or communities, and/or collaborative communities. The user may connect to and collaborate with other users who have searched for the same or similar search strings. The user may connect to and collaborate with other users who have read the same article or different articles and different web-sites about the same or similar topics. The user may connect to and collaborate with other users who have texted, tweeted, posted, updated, or searched for the same or similar string or topic. Using the profiles and/or any type of community, a user can define networks of other users, and can set permissions that control to what extent information about their searches is shared with users in these networks, and how these other users may interact with the user. Users of the interest matching, discovery, communication, and collaboration system can collaborate using email, instant messaging, chat, video conferencing, voice calls, and/or other mechanisms.

At step 268, optional additional information exchange may be performed between the client device 205 and the system 220 for other interest matching, discovery, communication, and/or collaboration. At step 270, further optional interactions may be performed between any of the client device 205, system 220, and/or the website 230.

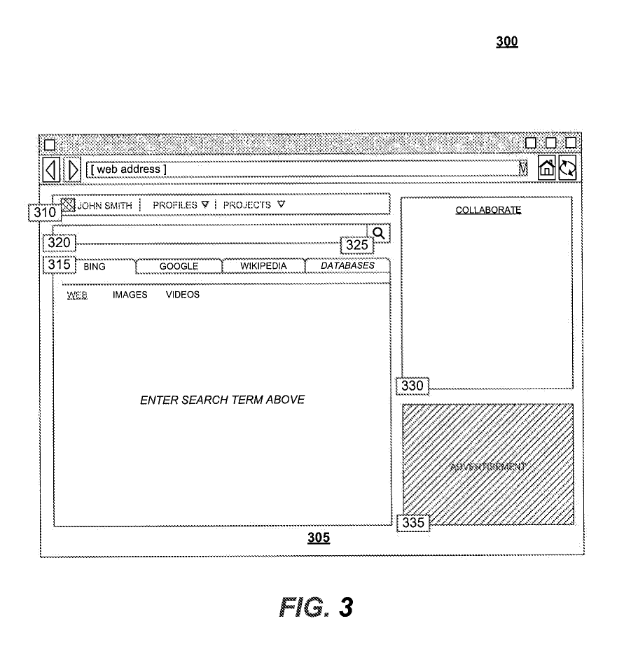

FIG. 3 shows an example 300 of how a search page 305 may look when displayed by the client device 205, for example, the web browser and/or plugin module 210. As shown in FIG. 3, the search page 305 includes information that identifies the user 310 (John Smith), and includes a number of different tabs 315 that relate to, for example different websites or search engines (Bing, Google, and Wikipedia in this example).

The page shown in FIG. 3 also includes a text field 320, wherein the user may type user input, search strings, and/or other information to be searched by the different websites or search engines. When the user enters user input or a search string into the text field 320 and indicates that the search should be performed, the web browser and/or plugin module 210 may initiate a search on the entered search string, using the search engine whose tab 315 is currently selected. The user may indicate that the search should be performed by, for example, clicking the button 325 shown with the magnifying glass that is next to the search bar (text field 320), for example by pressing an Enter key, and/or via any other appropriate input. The search page 305 may also include, for example, a “Collaboration” section 330 to allow user collaboration as described throughout the present disclosure. The search page 305 may also include an advertisement portion 335. The search page 305 may also include any buttons or features that are typically included in a web browser or plugin. One skilled in the art will recognize that the features of FIG. 3 are for exemplary purposes only and can be included in any combination, in any number, and in any position. Similarly, any of the features described with respect to FIG. 3 may be implemented in a “plugin” as described throughout the application.

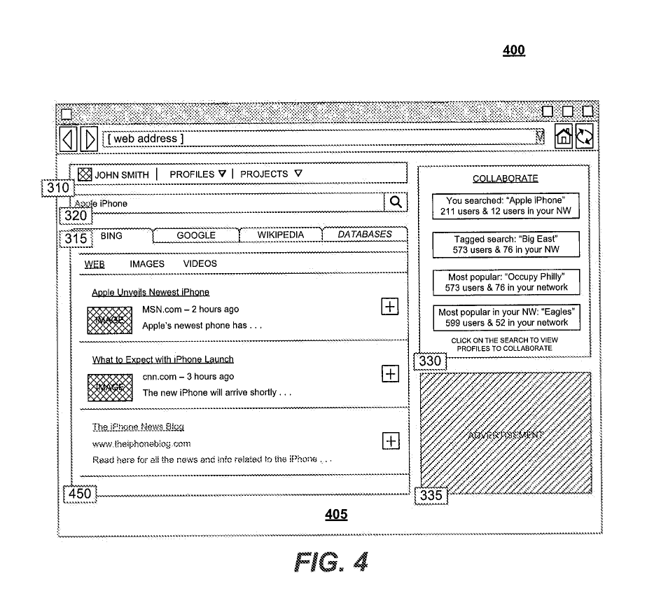

FIG. 4 shows an example 400 of a results web page 405 that may appear when displayed by the web browser and/or plugin 210. The example of FIG. 4 shares many of the features of FIG. 3 and therefore shares like numbers. However, FIG. 4 shows an example 400 in which a search has been performed and, therefore, more information is included in the results web page 405. In the example of FIG. 4, the user has searched for the term “Apple iPhone,” in the text field 320. The user is using Bing as the target search engine, as selected in one of the tabs 315. In the “Bing” tab 315, search results 450 are shown. The “Bing” tab 315 in this example shows results related to three different web pages, titled “Apple Unveils Newest iPhone,” “What to Expect with iPhone Launch,” and “The iPhone News Blog,” as shown in the search results 450. In the “Collaborate” section 330 of the results web page 405 shown in FIG. 4, information may be displayed to the user to allow interest matching, discovery, communication, and collaboration system as described through the present disclosure. For example, this may include any of the information described in detail with respect to FIGS. 2A-2B.

The search page 405 may also include any buttons or features that are typically included in a web browser or plugin. One skilled in the art will recognize that the features of FIG. 4 are for exemplary purposes only and can be included in any combination, in any number, and in any position. Similarly, any of the features described with respect to FIG. 4 may be implemented in a “plugin” as described throughout the application.

As described above, the “Collaborate” section 330 may include any of the interest matching, discovery, communication, and collaboration described throughout the present disclosure. In one example, if the user selects one of the buttons in the “Collaborate” section 330, a popup window may be generated and displayed by the web browser and/or plugin 210 that includes information related to the users referenced in the buttons. The popup window may display anonymous profiles of the users, and/or may display options for communicating with the that which corresponds to the selected button. Alternatively or additionally, the popup window may display contact information (such as email addresses of the users), or may display a text box that permits the user to send an email message to the selected person without showing the email address of the selected person to the user. In an instance where the text box that permits the user to send an email address to the selected person, the email message may be sent via the email interface of the system, as described above with reference to FIG. 1. Alternatively or additionally, the popup window may display one or more user interface elements that allow the user to initiate a video call with the users, without showing the video call-related contact information (i.e., the user name associated with the selected person's VoIP service account, or other identifying information) of the users. Alternatively or additionally, if a user whose information/profile is included in the popup window is currently online and logged in to the system, the popup window may include an instant messaging chat box that allows the two users to communicate. Alternatively or additionally, the popup window may include an array of communication options as dictated by the permissions set by the users and as processed by the web application and/or plugin server module 224. To obtain the information required to display the popup window and/or to initiate communications between users as described above, the web browser and/or plugin 210 may exchange one or more messages with the web application and/or plugin server module. These messages may be defined according to a technology such as PubNub, JSON, and/or any other appropriate technology.

One skilled in the art will recognize that a popup window need not be used and the information may be displayed in any form. Similarly, the information may be displayed via a website provided by the system described herein or via a plugin as described herein.

As another example, the “Collaborate” section 330 may display the names of different users, avatars/profile pictures, user names, and/or other information related to the different users identified. Alternatively or additionally, the “Collaborate” section 330 may include user interface elements that facilitate filtering the users that have searched for the same and/or similar user input, term, or search string based on factors such as the time frame that the searches were performed (i.e., only searched performed within the past week could be shown) and/or domains or social networks the users are associated with (i.e., only information about users within a top-level or corporate domain could be shown).

Although not shown in FIG. 4, the results web page 405 may also include one or more user interface elements (i.e., text boxes, buttons, and/or other input controls) that permit the user to annotate the search results displayed on the results web page. When the user annotates the search results, information about the annotations may be transmitted by the web browser and/or plugin 210 to the web application and/or plugin server module 224, and stored in the database 226 in the system 220. The information may indicate the active/selected community or collaborative community of the user, and/or the active/selected profile of the user, and/or other information related to the search results and annotations.

Alternatively or additionally, the results web page 405 may also include one or more user interface elements that permit the user to share their search results, search result annotations, and/or the search string that they have searched for via an external web site, such as Twitter or Facebook. When the user does so, information about the shared information (i.e., what it is (search results/annotated search results/search string), who it was shared with, how it was shared, and when) may be transmitted from the web browser and/or plugin 210 to the web application and/or plugin server module 224, and then the web application and/or plugin server module 224 may store this information in the database 226 in the system 220. The user may also elect to share entire search communities or collaborative communities, including the community or collaborative community saved user inputs, search strings and search results, and any other items, by entering the name or email address of the individual they intend on sharing the community or collaborative community with. The individual with whom the information is being shared does not need to be a registered user with the system. Invitations to share a community or collaborative community may be emailed to the individual (via the email interface in the system described with respect to FIG. 1).

Referring again to FIG. 2B, the web browser and/or plugin 210 and the HTTP server module 222/the web application and/or plugin server module 224 may perform one or more further interactions. This may include, for example, the web browser and/or plugin 210 periodically polling the web application and/or plugin server module 224 to obtain updated information to include in the “Collaborate” section 330 in the results web page 405, and then updating the results web page 405 accordingly.

The exchange of information described herein may be performed using a number of different technologies. For example, messages exchanged at step 253 and/or step 255 may be based on technologies such as REST, JSON, XML, SOAP, an RPC technology, an object serialization technology, and/or the messages may be defined according to any other appropriate format.

The HTTP server module 222 may transmit the results web page 405 (including, for example, the matching information and the search results information) to the web browser and/or plugin 210. The web browser and/or plugin 210 may display the results web page 405 that includes the matching information, for example, in the “Collaborative” section 330. The results web page 405 may appear as shown in FIG. 4. Here, the user may also interact with the user interface elements in the “Collaborate” section 330 of the results web page 405 to collaborate with other users, as described above. The web browser and/or plugin 210 and the HTTP server module 222/the web application and/or plugin server module 224 may perform one or more further interactions. This may include, for example, the web application and/or plugin server module 224 periodically polling the web application module to obtain updated information to include in the “Collaborate” section 330 in the results web page 405, and then updating the results web page 405 accordingly.

As mentioned above, in the example method of FIGS. 2A-2B, the user of the client device was logged in to the web site. As a variation on the method of FIGS. 2A-2B, a user who is not logged in may also search, using a method similar to that described above in FIGS. 2A-2B. In this variation on the method of FIGS. 2A-2B, the web application generates the search page and the results web page (i.e., the pages shown in FIGS. 3-4) such that they do not include any user-specific information (i.e., would not include the name of the user or any profile or community or collaborative community-related information). In such an instance, when the web application updates the database 226, the web application and/or plugin server 224 may update the database 226 to indicate that the search was performed by an anonymous user. This may be implemented in a number of different ways. As one example, when the web application and/or plugin server 224 adds a new entry to the database 226 to indicate that the user input or search string has been searched, the data that indicates the identifier of a user may be set to a predetermined/special value that indicates that the user is anonymous/unknown.

Alternatively or additionally, the system 220 may be configured to use only websites or search engines from which search results are provided directly to the client device 205, or may be configured to use only websites or search engines for which search results are passed through the system 220. In such an instance, the web application and/or plugin server 224 may be configured to perform a subset of the steps of FIGS. 2A-2B.

Although not shown in FIG. 4, the results web page 405 may also include one or more user interface elements (i.e., text boxes, buttons, and/or other input controls) that permit the user to annotate the search results displayed on the results web page. When the user annotates the search results, information about the annotations may be transmitted by the web browser and/or plugin 210 to the web application and/or plugin server 224, and stored in the database 226 in the system 220.

The following features with respect to the plugin may be used alternatively or in addition to all of the features described herein and all of the Figures described in detail herein. For sake of clarity, the term “plugin” may be used to refer to a web browser plugin, extension, add-on, or any other type of similar technology. A user may navigate with the web browser and/or plugin 210 to a page that is not the website or search page provided by the system 220. The page to which the user has navigated may be, for example, the homepage for Bing or Google, a page within the Facebook web site, and/or any other web page. The user inputs a user input, other information, and/or a search string (as described in detail above). The search or other query may be performed by the web application and/or plugin server 224 in conjunction with the website 230 or the search or other query may be performed directly at the website 230 by a user. In an instance where the user has navigated to a website, search engine, or database page (such as the Google or Bing home pages), this may include the user inputting data into a search text box. Alternatively or additionally, this may include the user entering the user input, other information, and/or search string into a search box/search bar or address bar that is present in the user interface of the web browser and/or plugin 210 or directly at the website 230.

The website 230 may process the request and generate a search results web page. The website 230 may transmit the search results web page back to the user via the web browser and/or plugin 210. The web browser and/or plugin 210 may display the search results web page to the user in any manner. The web browser and/or plugin 210 in the client device may send information regarding the search to the browser add-on, extension, and/or plugin server in the system 220, generally referred to as the web application and/or plugin server 224. This information may include, for example, the target search engine for the search (i.e., information that indicates Bing, Google, etc.), the user input, the other information, the search string, the IP address of the client device, an identifier of the user, and/or other information. The information may include any of the information described throughout the present disclosure as input by a user or captured by the system 220.

The web application and/or plugin server 224 processes the information transmitted by the web browser and/or plugin 210. This may include adding an entry to the database 226 that indicates that the user input, other information, or search string has been searched. The entry may include one or more of: a unique identifier for the entry; a time the entry is being added; the IP address used by the client device; the target search engine; information that indicates the source of the search (i.e., that it comes from the browser add-on, extension, and/or plugin); and an identifier of the user. In an instance where the database is a relational database, this may include, for example, adding one or more rows that indicate the above-mentioned information to a table. Alternatively or additionally, this may include similar processing such as that described above as performed by the web application and/or plugin 210.

The web application and/or plugin server module 224 generates matching information based on the user input, other information, or search string. This may be performed as described in detail above. The web application and/or plugin server module may send the generated matching information to the web browser and/or plugin 210 as described in detail above. The exchange of information described in may be performed using a number of different technologies. For example, messages exchanged may be based on technologies such as REST, JSON, XML, SOAP, an RPC technology, an object serialization technology, and/or the messages may be defined according to any other appropriate format.

The web browser and/or plugin 210 may display the matching information as described above in detail. This may include, for example, displaying information such as that described above with respect to the “Collaborate” section 330 in the example results web page 405 of FIG. 4. Alternatively or additionally, the web browser and/or plugin 210 may receive user input for interacting with users whose names/pictures are displayed by the web browser and/or plugin 210, in a similar or identical fashion to the features described above in detail. The web browser and/or plugin 210 in the client device 205 and the web application and/or plugin server module 224 may perform one or more further interactions. These may include, for example, the web browser and/or plugin 210 periodically polling the web application and/or plugin server module 224 to obtain updated information to display, and then updating the display of the web browser and/or plugin 210 accordingly.

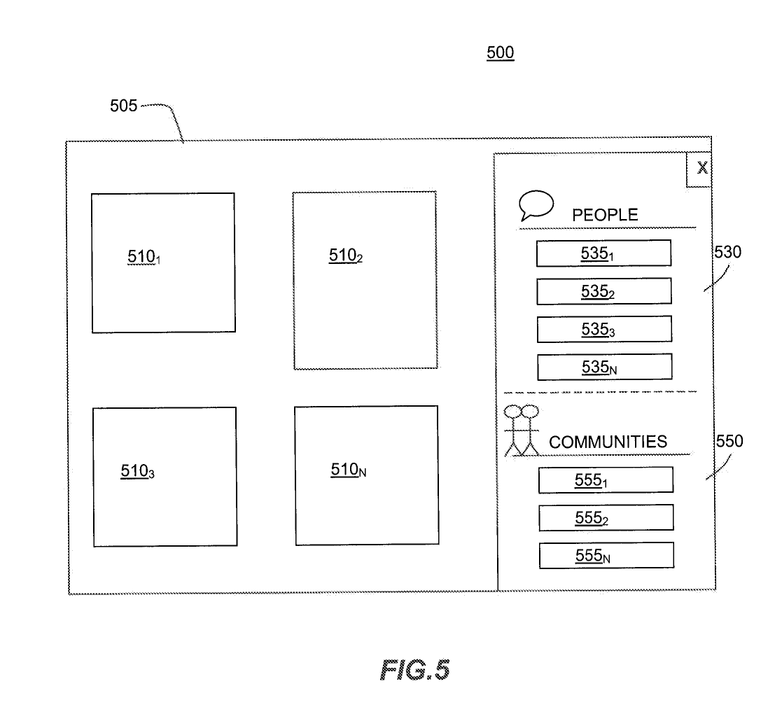

FIG. 5 shows an example 500 of a web page 505 for use with any of the features described herein. In this example, the web page 505 includes any variety and any number of content portions 510_{1-N}. The web page 505 may also include a window generated by the system as in any of the examples described above, whereby the window includes a “People” section 530 and a “Communities” section 550. These sections are for exemplary purposes only, and one skilled in the art will recognize that there may be sections for any of the features described throughout the present disclosure. The “People” section 530 may include one or more information areas 535_{1-N}. The information areas 535_{1-N} may include, for example, information and/or pictures related to information (for example, matching information) generated by the system 220 in any of the examples provided herein. The “Communities” section 550 may include one or more information areas 555_{1-N}. The information areas 555_{1-N} may include, for example, community information and/or pictures related to information (for example, matching information) generated by the system 220 in any of the examples provided herein.

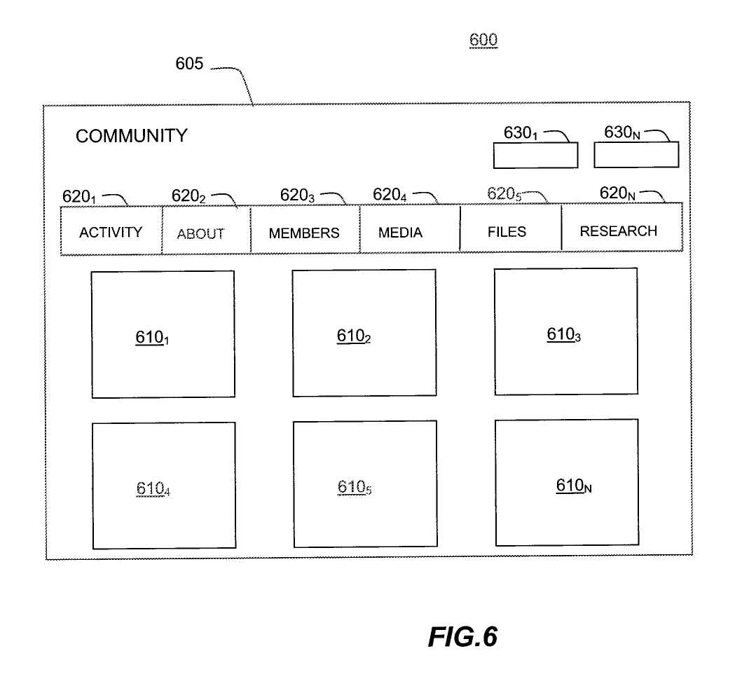

FIG. 6 shows an example 600 of a community web page 605. In this example, the community web page 605 includes any variety and any number of content portions 610_{1-N}. The content portions 610_{1-N} may include for example any information described above as being available in any of the types of communities described above. The community web page 605 may also include any number of tabs 620_{1-N}. In this example, tab 620₁ shows an Activity tab, tab 6202 shows an About tab, tab 620₃ shows a Members tab, tab 620₄ shows a Media, tab 620₅ shows a Files tab, and tab 620_{N} shows a Research tab. One skilled in the art will recognize that any number of tabs may be used and each tab may represent any of the features of the present disclosure described herein. Clicking on any of the tabs 620_{1-N} may cause the content portions 610_{1-N} to change or be updated. The community web page 605 may also include any number of additional portions and/or buttons 630_{1-N}.

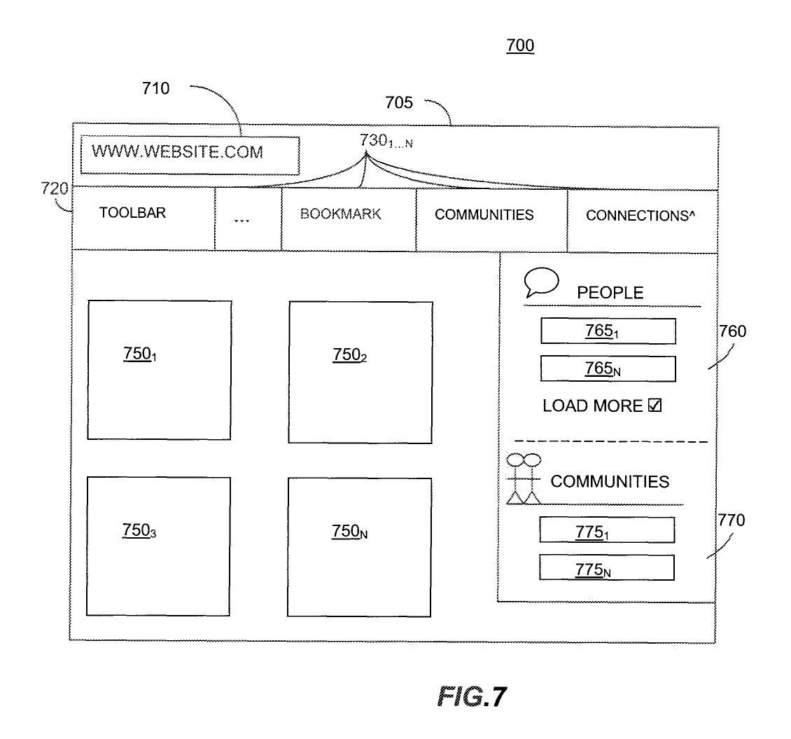

FIG. 7 shows an example 700 of a web page 705 that includes a toolbar 720. The web page 705 may be any web page produced by any outside company (though one skilled in the art will recognize that the web page 705 may also be a web page in accordance with the system described herein). The web page 705 includes a panel 710 for entering, for example, a URL. The toolbar 720 may include any number of tabs 730_{1-N}. In this example, the tabs 730_{1-N} include a Bookmark tab, a Communities tab, and a Connections tab. One skilled in the art will recognize that any number of tabs 730_{1-N} may be supported and any of the tabs 730_{1-N} may include features related to any of the features described in detail throughout the present disclosure. The web page 705 also includes any variety and any number of content portions 750_{1-N}. In this example, the Connections tab 730_{N} has been selected. The Connections tab 730_{N}, for example when selected, may open a window (for example, a popup window). The information shown in the window may be information generated by the system as in any of the examples described above. The window for the Connections tab 730_{N} may include a “People” section 760 and a “Communities” section 770. These sections are for exemplary purposes only, and one skilled in the art will recognize that there may be sections for any of the features described throughout the present disclosure. The “People” section 760 may include one or more information areas 765_{1-N}. The information areas 765_{1-N} may include, for example, information and/or pictures related to information (for example, matching information) generated by the system 220 in any of the examples provided herein. The “Communities” section 770 may include one or more information areas 775_{1-N}. The information areas 775_{1-N} may include, for example, community information and/or pictures related to information (for example, matching information) generated by the system 220 in any of the examples provided herein. One skilled in the art will recognize that each of the tabs 730_{1-N} may generate a window that includes any of the information described as being generated or displayed throughout the present disclosure.

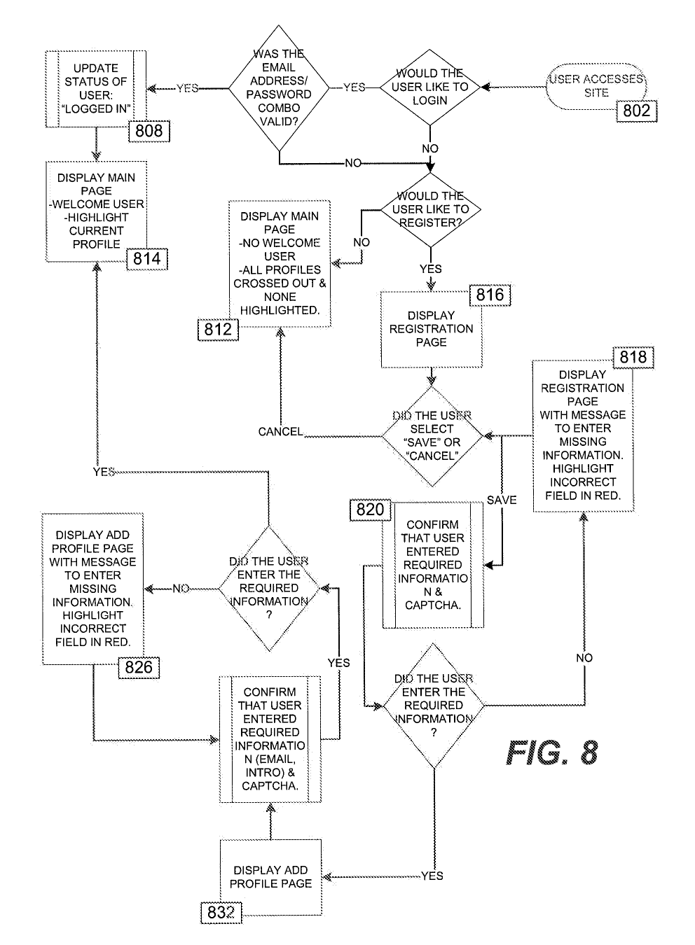

FIG. 8 shows a method 800 that may be performed using the web browser and/or plugin 210 in the client device 205 and the system 220 for registering a user with the system 220. At step 802, the user accesses the website or plugin provided by the system 220. If the user is already registered with the system 220 and would like to log in, the user may enter an email address and password, and log in to the system (step 808). Once the user is logged in, a main page may be displayed to the user (step 814). The main page may be identical or similar to the pages described and shown above in detail. If the user does not want to log in, the user has the option of registering with the system 220. If the user would like to register with the system 220, a registration page may be displayed to the user (step 816). If the user does not want to register with the system 220, a main page may be displayed to the user (step 812). This main page may be identical or similar to the page described and shown above in detail, though may not include specific user/profile information.

If the user begins to enter registration information into the registration page but does not enter all the required information, the registration page may be displayed again, with one or more messages that highlight the missing information (step 818). If the user correctly entered information into the registration form, the user is then presented with a Completely Automated Public Turing test to tell Computers and Humans Apart (CATCHPA) form (step 820). If the user correctly enters information into the CATCHPA form, an add profile page is displayed to the user (step 832). In the add profile page, the user can provide data such as a name for the profile (whether it is the “work” profile or the “friends” profile, etc.), what interest the profile may relate to, an email address to associate with the profile, and other users that should be associated with profile. The user may also be presented with a CATCHPA. If this information is entered correctly, the data provided by the user is added to the database in the system 220, and the method proceeds again to step 814. If the information is entered incorrectly, the method proceeds to step 826, where the add profile page is displayed again, with one or more messages that highlight the missing/incorrect information.

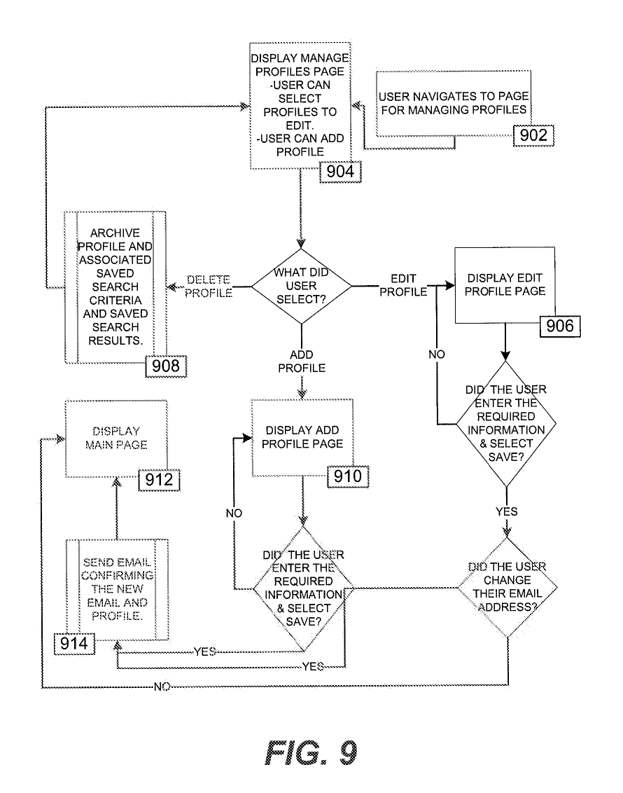

FIG. 9 shows a method 900 that may be performed using the web browser and/or plugin 210 in the client device 205 and the system 220 for managing profiles of a user. At step 902, the user navigates to a profile management web page in the website or plugin provided by the system 220. At step 904, the profile management webpage is displayed to the user. If the user selects an edit profile link at step 904, an edit profile page is displayed (step 906). If the user enters information to change the email address that is associated with the selected profile, then information about the edited profile is stored in the database 226 in the system 220, and the web application and/or plugin 210 transmits an email to the user (for example, via the email interface in the system as shown in FIG. 1) confirming that the email address has been changed; then, a main page (i.e., a page identical or similar to the page described and shown above) may be displayed to the user (step 912).

If the user selects an add profile link at step 904, then an add profile page is displayed to the user (step 910). If the user adds the information required to add a new profile, then information about the new profile is stored in the database 226 in the system 220, and the web application and/or plugin 210 transmits an email to the user (for example, via the email interface in the system as shown in FIG. 1) confirming that the email address has been changed; then, a main page (i.e., a page identical or similar to the page described and shown above) may be displayed to the user (step 912). If the users selects a delete profile link at step 904, then information related to the selected profile (including search information and results related to the profile) is archived (step 908). It should be understood that, although not necessarily stated explicitly in the above description of the Figures, each or any of the web pages described with reference to the Figures may be generated by the web application and/or plugin server module 224 in the system 220, may be transmitted to the web browser and/or plugin 210 in the client device 205 via, for example, the HTTP server module 222 in the system 220, and may be displayed by the web browser and/or plugin 210 in the client device 205. Further, the user input described above with reference to the Figures as provided by the user may be received by the web browser and/or plugin 210 and transmitted to the web application and/or plugin server module 224 via the HTTP server module 222.

In addition to the above features, the web application of FIG. 1 may generate one or more web pages or other display such as the plugin (which may be received by and displayed by the web browser module in the client device), that include information such as, for example: the most popular search strings that have been searched for by all users of the system within a given time frame (such as within the last day, week, or month); the number of users that have searched for the most popular search strings; the most popular searches within a given network of the user of the client device (i.e., the most popular searches performed by all users associated with a given profile); or the number of users that within a given network of the user of the client device that have searched for the most popular search strings.

The web application of FIG. 1 may also generate one or more web pages or other display such as the plugin (which may be received by and displayed by the web browser module in the client device) that permit the user of the client device to view profiles of other users that are in the users' network (and/or associated with a given profile). Alternatively or additionally, the web application of FIG. 1 may also generate one or more web pages (which may be received by and displayed by the web browser module in the client device) that permit the user of the client device to search for other users of the system based on various parameters (such as interests, etc.), and to view information such as profiles of the other users.

Alternatively or additionally, the web application of FIG. 1 may also generate one or more web pages or other display such as the plugin (which may be received by and displayed by the web browser module in the client device) that permit the user to initiate a video call or instant messaging session with users whose profiles they have searched for. These web pages may or may not include the contact information (i.e., user name associated with a VoIP service such as Skype, or other identifying information) of the searched-for users. In an instance where the pages do not include the contact information, the system may handle the instant messaging session or video call via the interaction module.

Alternatively or additionally, the web application of FIG. 1 may also generate one or more web pages or other display such as the plugin (which may be received by and displayed by the web browser module in the client device) that are specifically tailored for vendors to interact with users that have searched on terms that relate to the vendors' products/services. These pages may permit the vendors to contact the users via instant messaging or video call (via the interaction module in the interaction module in the search system). Further, the web application may also generate web pages that may be presented to vendors that include profiles of users who have searched for certain search terms. This functionality may be provided by the analytics module and/or the web application module. For example, the web application (in conjunction with the analytics module) may provide a search page that, in response to a search for a given term, provides information regarding users that have searched for the term. The vendor may then filter this data and send email messages (via the email interface module in the system) to a selected portion of the users that have searched for the term. It should also be noted that vendors may also contact users via the mechanisms for collaboration described herein, just as any other user would. The venders may also be notified regarding searches of their products or competitors products. Based on any of the information described above, a vendor may be allowed to bid for or pay for the ability to advertise to at least those who searched for those products. Similarly, a vendor may bid, bargain, or pay for the ability to provide a particular deal for users that searched on those products or other users.

Referring again to FIG. 3, the search page may also include a “Databases” tab as part of the tabs 315. When this tab is selected, the web browser and/or plugin 210 may display a “Databases” tab that includes one or more user interface elements (i.e., text boxes, buttons, and/or other input controls) that permit the user to modify the search engines whose tabs appear in the results page. With the user interface elements, the user may remove any of the tabs, and/or may search for other search engines that are available to use with the system. Alternatively or additionally, the user interface elements may permit the user to request that another search engine be added for use with the system 220.

The addition of a search engine for use with the system 220 may be performed in a number of different ways. For example, the entity (the individual, business, or other organization) that operates/controls the system may publish an API or other interface that a search engine needs to implement, in order to be integrated into the system. Alternatively, the modules in the system (such as the web application/plugin server module 224) may be configured to implement a public API/other interface that is offered by a search engine. In either case, interactions between the system 220 and/or the client device 205 and the new search engine may be implemented using the published API/other interface, and information about the new search engine (such as web addresses associated with the search engines, how interactions with the search engine are performed via the API/other interface, and/or other information) may be stored in the database 226 in the system 220.

FIG. 10 shows an example 1000 computing device 1005 that may be used to implement features describe herein. The computing device 1005 includes a processor 1010, memory device 1015, communication interface 1020, peripheral device interface 1025, display device interface 1030, and storage device 1035. FIG. 10 also shows a display device 1040, which may be coupled to or included within the computing device 1005.

The memory device 1015 in the computing device 1005 may be or include a device such as a Dynamic Random Access Memory (D-RAM), Static RAM (S-RAM), or other RAM or a flash memory. The storage device 1035 may be or include a hard disk, a magneto-optical medium, an optical medium such as a CD-ROM, a digital versatile disk (DVDs), or Blu-Ray disc (BD), or other type of device for electronic data storage.

The communication interface 1020 in the computing device 1005 may be, for example, a communications port, a wired transceiver, a wireless transceiver, and/or a network card. The communication interface 1020 may be capable of communicating using technologies such as Ethernet, fiber optics, microwave, xDSL (Digital Subscriber Line), WLAN technology, wireless cellular technology, and/or any other appropriate technology.

The peripheral device 1025 interface in the computing device 1005 may be an interface configured to communicate with one or more peripheral devices. The peripheral device interface may operate using a technology such as Universal Serial Bus (USB), PS/2, Bluetooth, infrared, serial port, parallel port, and/or other appropriate technology. The peripheral device interface may, for example, receive input data from an input device such as a keyboard, a mouse, a trackball, a touch screen, a touch pad, a stylus pad, and/or other device.

The display device interface 1030 in the computing device 1005 may be an interface configured to communicate data to the display device 1040. The display device 1040 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1030 may operate using technology such as Video Graphics Array (VGA), Super VGA (S-VGA), Digital Visual Interface (DVI), High-Definition Multimedia Interface (HDMI), or other appropriate technology. The display device interface 1030 may communicate display data from the processor 1010 to the display device 1040 for display by the display device 1040. As shown in FIG. 10, the display device 1040 may be external to the computing device 1005, and coupled to the computing device 1005 via the display device interface 1030. Alternatively, the display device 1040 may be included in the computing device 1005.

An instance of the computing device 1005 of FIG. 10 may be configured to perform any feature or any combination of features described herein as performed by the client device 205. In such an instance, the memory device 1015 and/or the data storage device 1035 in the computing device 1005 may store instructions which, when executed by the processor 1010 in the computing device 1005, cause the processor 1010 to perform any feature or any combination of features described herein as performed by each or any of the modules described herein as included in the client device 205 (such as the web browser module and/or the browser add-on, extension, and/or plugin module, and/or any other modules mentioned herein as included within the client device 205). Alternatively or additionally, each or any of the features described herein as performed by the modules in the client device 205 (such as the web browser and/or plugin 210 that may include the browser add-on, extension, and/or plugin module, and/or any other modules mentioned herein as included within the client device 205) may be performed by the processor 1010 in conjunction with the memory device 1015, communication interface 1020, peripheral device interface 1025, display device interface 1030, and/or storage device 1035.

An instance of the computing device 1005 of FIG. 10 may be configured to perform any feature or any combination of features described herein as performed by each or any of the modules in the system (i.e., the administrative module, web application and/or plugin server module, email interface module, HTTP server module, the interaction module, and/or the analytics module as shown and described with respect to at least FIG. 1, 2A, or 2B). In such an instance, the memory device 1015 and/or the data storage device 1035 in the computing device 1005 may store instructions which, when executed by the processor in the computing device 1005, cause the processor 1010 to perform any feature or any combination of features described herein as performed by each or any of the modules described herein as included in the system.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although specific web pages are shown in and described with reference to the Figures described above, it should be understood that these web pages are provided as examples, and that the functionality provided by these web pages (and/or the user interface elements included in these web pages) may be distributed across any number of different web pages that may be generated by the web application module and transmitted to the client device.

Although the methods and features are described herein with reference to the example architecture of at least FIGS. 1, 2A, and 2B, the methods and features described herein may be performed, mutatis mutandis, using any appropriate architecture and/or environment. Further, although the web browser and/or plugin in the client device is described herein as implementing specific web browser technologies, it should be understood that the features described herein as performed by the web browser and/or plugin may alternatively or additionally be implemented using a specific-purpose application, including but not limited to an application that is configured to run on an operating system such as Android, Windows Mobile, Apples iOS, and/or any other appropriate mobile operating system or general-purpose operating system.

Although features and elements are described herein in particular combinations, each feature or element can be used alone or in any combination with or without the other features and elements. Any single embodiment herein may be supplemented with one or more element from any one or more other embodiment herein. Any single element of an embodiment herein may be replaced with one or more element from any one or more other embodiment herein. For example, each feature or element as described herein with reference to any one of the Figures referenced above may be used alone without the other features and elements or in various combinations with or without other features and elements from each or any combination of the other Figures. Each or any combination of features described herein may be considered optional. Sub-elements of the methods and features described herein with reference to each or any Figure may be performed in any order (including concurrently), in any combination or sub-combination.

What is claimed is:

1. A method for use of an interest matching, discovery, communication or collaboration system, the method comprising:
storing information related to a plurality of users in a database;
receiving user input from a client device;
storing the user input in the database;
generating matching information based on the user input and the information related to the input of a plurality of users, the matching information including user information that identifies at least one user of the plurality of users that transmitted user input that is the same or similar to the user input received from the client device; and
transmitting the matching information to the client device, the matching information allowing a user of the client device to communicate with the at least one user identified in the user information via the interest matching, discovery, communication or collaboration system.

2. The method of claim 1, wherein the receiving user input further includes receiving additional information, the additional information including one or more of: a web address accessed by the user of the client device, a title of an article read by the user of the client device, text from the article read by the user of the client device, and tags or other information associated with the article read by the user of the client device.

3. The method of claim 2, wherein the generating matching information is further based on the additional information.

4. The method of claim 1, further comprising storing user profile information in the database for each of the plurality of users, the user profile information including information specific to each user.

5. The method of claim 4, wherein the user profile information includes one or more profiles including one or more of a public profile, a work profile, and a school profile.

6. The method of claim 5, wherein each profile includes different matching settings.

7. The method of claim 6, further comprising storing, in the database, at least one permission setting for each of the user profiles.

8. The method of claim 1, wherein the interest matching, discovery, communication or collaboration setting includes a browser toolbar, extension or plugin for capturing the user input at the client device.

9. The method of claim 1, wherein the user input is a search string entered by the user of the client device at a website.

10. The method of claim 1, wherein the allowing the user of the client device to communicate with the at least one user includes allowing the user to communicate via at least one of email, instant message, chat, a video conference, or a voice call.

11. The method of claim 1, further comprising maintaining at least one community, per profile, in which the plurality of users may communicate and upload and share information of any type, including comments, updates, images, videos, files, polls, questions and events.

12. The method of claim 1, further comprising a module that aggregates information regarding users that have input the same or similar information.

13. The system of claim 12, wherein the aggregated information is exported from the system via electronic means.

14. An interest matching, discovery, communication or collaboration system comprising:
a database configured to store information related to a plurality of users;
a plugin server configured to receive user input from a client device;
the database configured to store the user input;
a processor configured to generate matching information based on the user input and the information related to the plurality of users, the matching information including user information that identifies at least one user of the plurality of users that transmitted user input similar to the user input received from the client device; and
the plugin server configured to send the matching information to the client device, the matching information allowing a user of the client device to communicate with the at least one user identified in the user information via the interest matching, discovery, communication or collaboration system.

15. The system of claim 14, wherein the plugin server is further configured to receive additional information with the user input, the additional information including one or more of: a web address accessed by the user of the client device, a title of an article read by the user of the client device, or text from the article read by the user of the client device, and tags or other information associated with the article read by the user of the client device.
wherein the processor is further configured to generate the matching information based on the additional information.

16. The system of claim 14, wherein the database is further configured to store user profile information for each of the plurality of users, the user profile information including information specific to each user.

17. The system of claim 14, wherein the client device includes a plugin for capturing the user input at the client device and wherein the user input is a search string entered by the user of the client device at a website.

18. The system of claim 14, further comprising a module that aggregates information regarding users that have input the same or similar information.

19. The system of claim 18, wherein the aggregated information is exportable from the system.
